(19) United States
(12) Patent Application Publication
(10) Pub. No.: US 2024/0125167 A1
(43) Pub. Date: Apr. 18, 2024

(54) A Precast Building Component and Window Frame System and A Method of Manufacturing a Precast Building Component and Window Frame System

(71) Applicant: Tectonic Facades Limited, Newcastle-Under-Lyme (GB)

(72) Inventor: Harvey Richard Thorp, Newcastle-Under-Lyme (GB)

(73) Assignee: Tectonic Facades Limited, Newcastle-Under-Lyme (GB)

(21) Appl. No.: 18/263,168

(22) PCT Filed: Jan. 28, 2022
(86) PCT No.: PCT/GB2022/050236

§ 371 Date: Jul. 27, 2023

(30) Foreign Application Priority Data
Jan. 28, 2021 (GB) 2101209.1

(51) Int. Cl. E06B 1/58; E06B 1/24; E06B 1/60

(52) U.S. Cl. CPC E06B 1/58; E06B 1/24; E06B 1/6015

(57) ABSTRACT

A method and a precast building component and window frame system. The method comprising: positioning a window frame within a window opening of a precast building component, wherein the precast building component comprises solidified settable material; forming a void between the window frame and the precast building component, wherein the void surrounds the window frame; wherein barrier material is placed within the gap between opposing surfaces of the window frame and the precast building component to form a boundary of the void; filling the void with a settable adhesive sealant; wherein the settable adhesive sealant, once set, provides a continuous seal that surrounds the window frame and supports the window frame within the window opening.

### TECHNOLOGICAL FIELD

Embodiments of the present disclosure relate to a precast building component and window frame system and a method of manufacturing a precast building component and window frame system. Some relate to a precast building component and window frame system and a method of manufacturing a precast building component and window frame system in the construction industry.

### BACKGROUND

Previous methods of installing windows in precast building components rely on multiple products cut and bonded onsite which can lead to variants in performance window to window. There is a requirement for a new method of installing windows within precast building components that is consistent, does not rely on highly skilled workmanship and provides the necessary performance in terms of air tightness, water tightness and structural support.

### BRIEF SUMMARY

According to various, but not necessarily all, embodiments there is provided a method comprising:
positioning a window frame within a window opening of a precast building component, wherein the precast building component comprises solidified settable material;
forming a void between the window frame and the precast building component, wherein the void surrounds the window frame; wherein barrier material is placed within the gap between opposing surfaces of the window frame and the precast building component to form a boundary of the void;
filling the void with a settable adhesive sealant;
wherein the settable adhesive sealant, once set, provides a continuous seal that surrounds the window frame and supports the window frame within the window opening.

In some, but not necessarily all, examples, the seal provides a hermetic seal between the window frame and the precast building component.

In some, but not necessarily all, examples, the settable adhesive sealant is a pourable liquid.

In some, but not necessarily all, examples, the precast building component is laid flat whilst the window frame is positioned and whilst the void is filled with the settable adhesive sealant.

In some, but not necessarily all, examples, the precast building component is stood up whilst the window frame is positioned and whilst the void is filled with the settable adhesive sealant, wherein additional void boundaries are provided to prevent the settable adhesive sealant escaping the void.

In some, but not necessarily all, examples, one or more brackets are fitted to the window frame and the precast building component to provide additional support to support the window frame within the window opening.

In some, but not necessarily all, examples, the method additionally comprises:
forming a secondary continuous seal that surrounds the window frame and supports the window frame within the window opening;
wherein the secondary continuous seal is formed by:
forming a secondary void between the window frame and the precast building component, wherein the secondary void surrounds the window frame; wherein secondary barrier material is placed within the gap between opposing surfaces of the window frame and the precast building component to form a secondary boundary;
filling the secondary void with a settable adhesive sealant;
wherein the settable adhesive sealant, once set, provides the secondary continuous seal;
wherein an air gap and/or the boundary separates the continuous seal and the secondary continuous seal.

In some, but not necessarily all, examples, the void is filled by filling the settable adhesive sealant up to be level with a face of the precast building component.

In some, but not necessarily all, examples, formwork components are placed on a face of the precast building component to form an additional boundary of the void, wherein the formwork is spaced from the gap between opposing surfaces of the window frame and the precast building component so that when the void is filled with the settable adhesive sealant, part of the seal is bonded to at least part of the face of the precast building component.

In some, but not necessarily all, examples, a face of the precast building component comprises a step surrounding the gap between the opposing surfaces of the window frame and the precast building component, wherein the step forms an additional void boundary, wherein when the settable adhesive sealant fills the void it fills the step, such that part of the seal is bonded to at least part of the face of the precast building component.

In some, but not necessarily all, examples, the solidified settable material is cementitious.

In some, but not necessarily all, examples, the solidified settable material comprises concrete.

In some, but not necessarily all, examples, one or more glass panes are secured within the window frame before positioning the window frame within the window opening.

In some, but not necessarily all, examples, one or more glass panes are secured within the window frame after positioning the window frame within the window opening.

According to various, but not necessarily all, embodiments there is provided a precast building component and window frame system, comprising:
a precast building component, the precast building component comprising solidified settable material and a window opening;
a window frame supported within the window opening;
wherein the window frame is surrounded by a continuous seal, wherein the continuous seal supports the window frame within the window opening;
wherein the continuous seal comprises a settable adhesive sealant that has set.

In some, but not necessarily all, examples, the seal provides a hermetic seal between the window frame and the precast building component.

In some, but not necessarily all, examples, the system additionally comprises one or more brackets, fitted to the window frame and the precast building component, to provide additional support to support the window frame within the window opening.

In some, but not necessarily all, examples, the system additionally comprises a secondary continuous seal comprising settable adhesive sealant that has set, wherein the secondary continuous seal surrounds the window frame and supports the window frame within the window opening;
wherein an air gap and/or the boundary separates the continuous seal and the secondary continuous seal.

In some, but not necessarily all, examples, one end of the seal is level with a face of the precast building component.

In some, but not necessarily all, examples, part of the seal is bonded to at least part of a face of the precast building component.

In some, but not necessarily all, examples, a face of the precast building component comprises a step surrounding the gap between the opposing surfaces of the window frame and the precast building component, wherein the seal is bonded to the step.

In some, but not necessarily all, examples, the system additionally comprises one or more membranes that cover at least part of a surface of the window frame, one end of the continuous seal, and at least part of a face of the precast building component.

In some, but not necessarily all, examples, the solidified settable material is cementitious.

In some, but not necessarily all, examples, the solidified settable material comprises concrete.

In some, but not necessarily all, examples, one or more glass panes are secured within each window frame.

According to various, but not necessarily all, embodiments there is provided examples as claimed in the appended claims.

### BRIEF DESCRIPTION

Some examples will now be described with reference to the accompanying drawings in which:

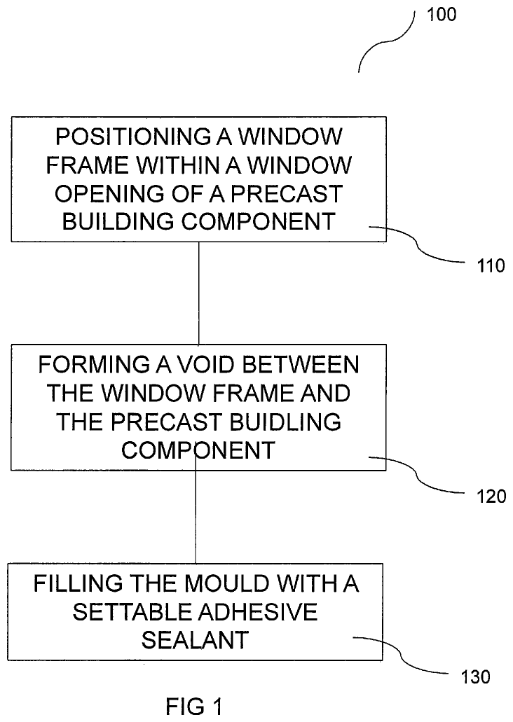

FIG. 1 shows an example method described herein;

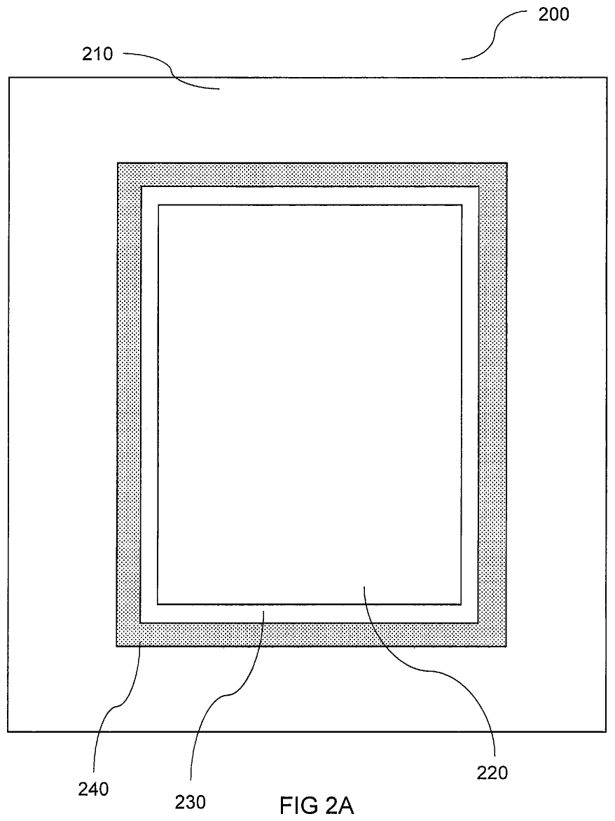

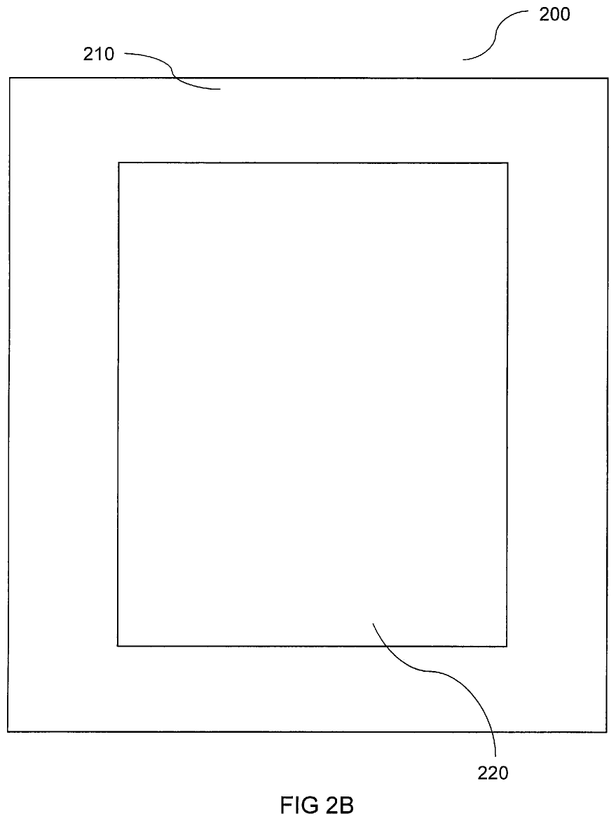

FIG. 2A shows an example system described herein;

FIG. 2B shows an example of the subject matter described herein;

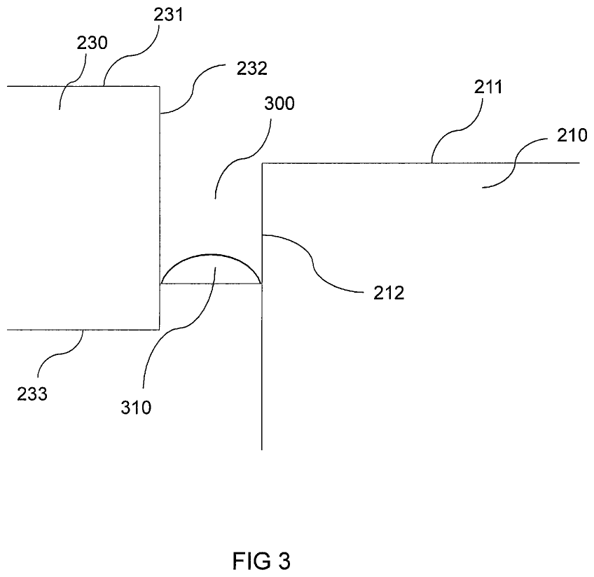

FIG. 3 shows an example of the subject matter described herein;

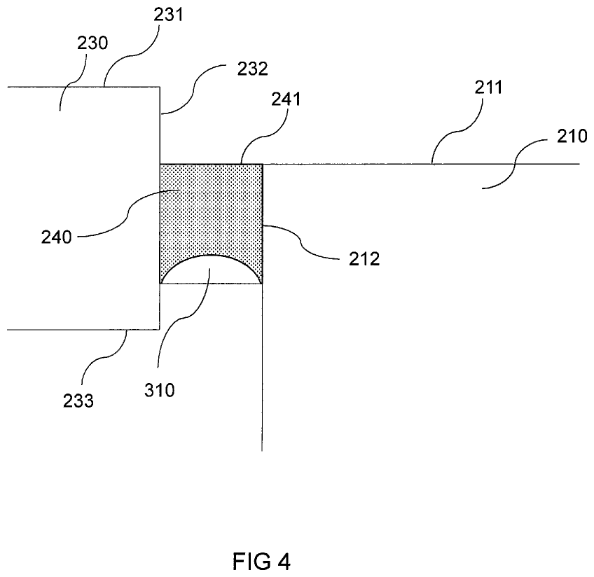

FIG. 4 shows an example of the subject matter described herein;

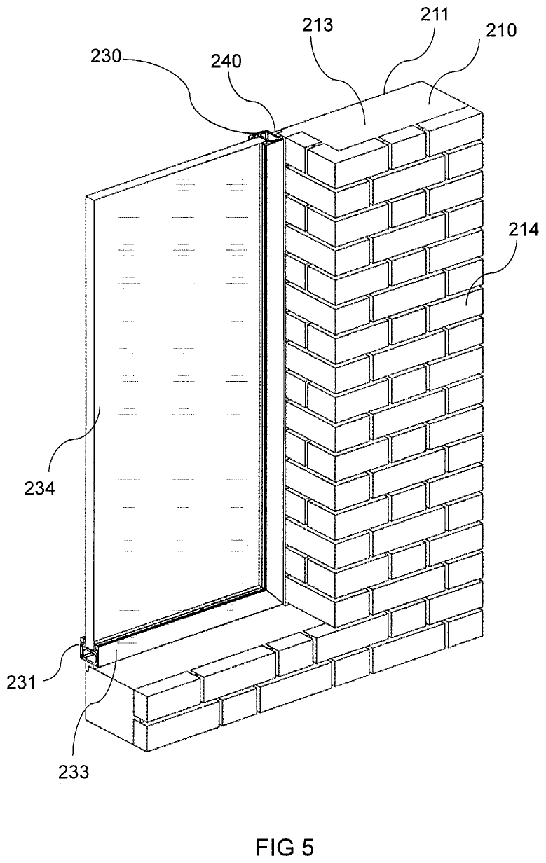

FIG. 5 shows an example of the subject matter described herein;

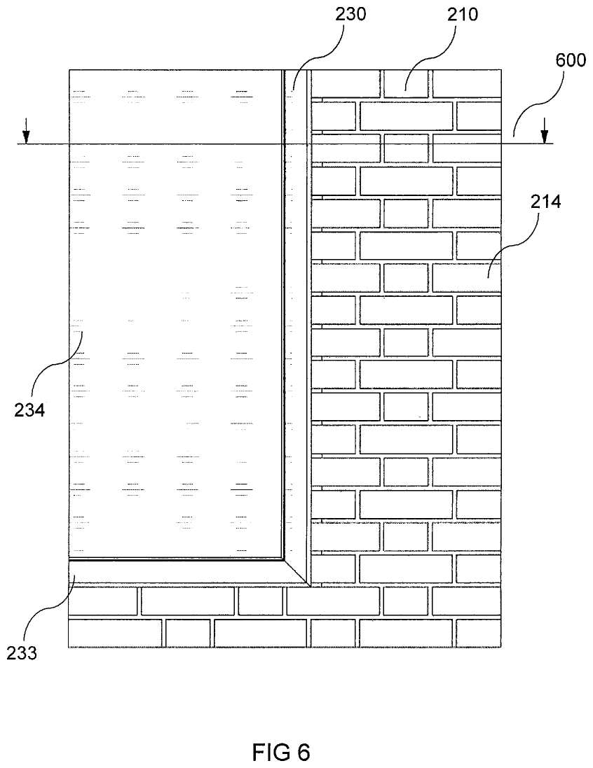

FIG. 6 shows an example of the subject matter described herein;

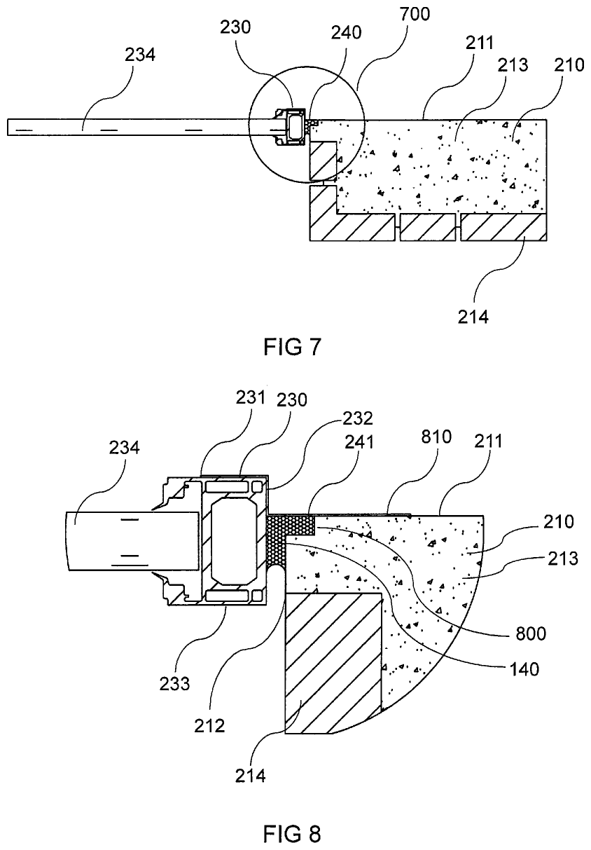

FIG. 7 shows an example of the subject matter described herein;

FIG. 8 shows an example of the subject matter described herein;

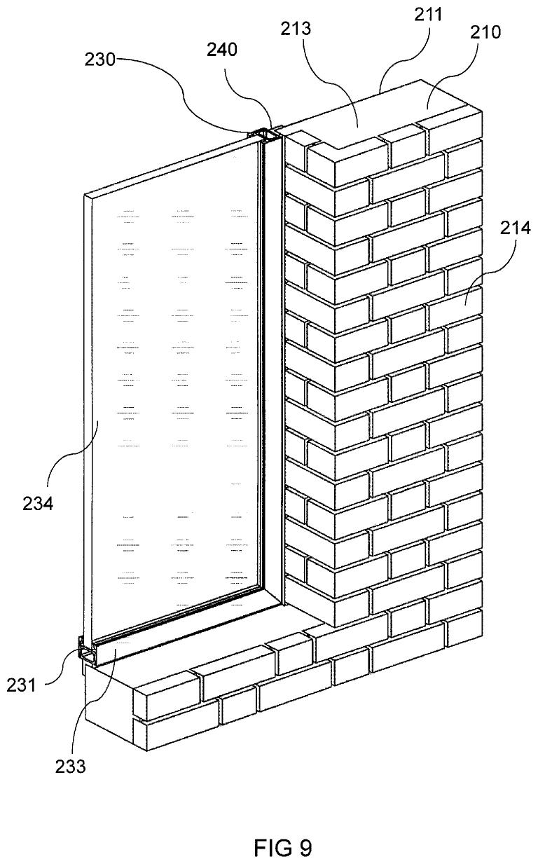

FIG. 9 shows an example of the subject matter described herein;

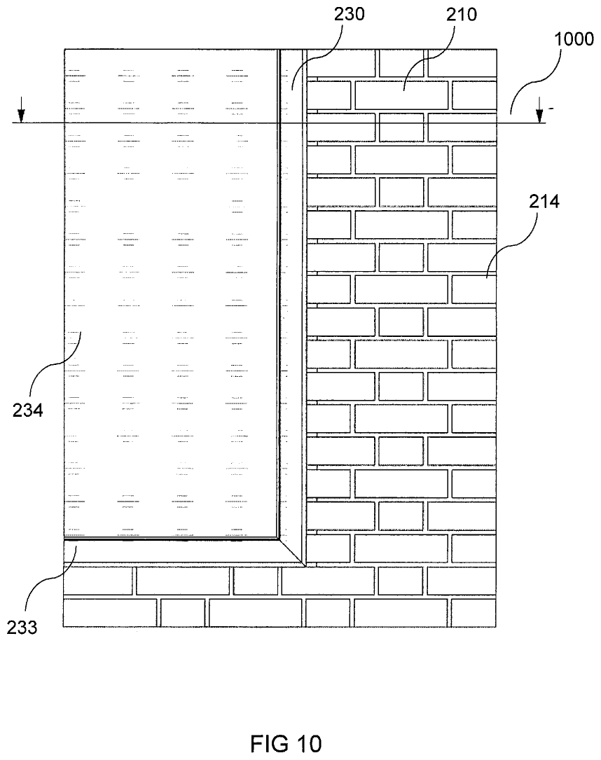

FIG. 10 shows an example of the subject matter described herein;

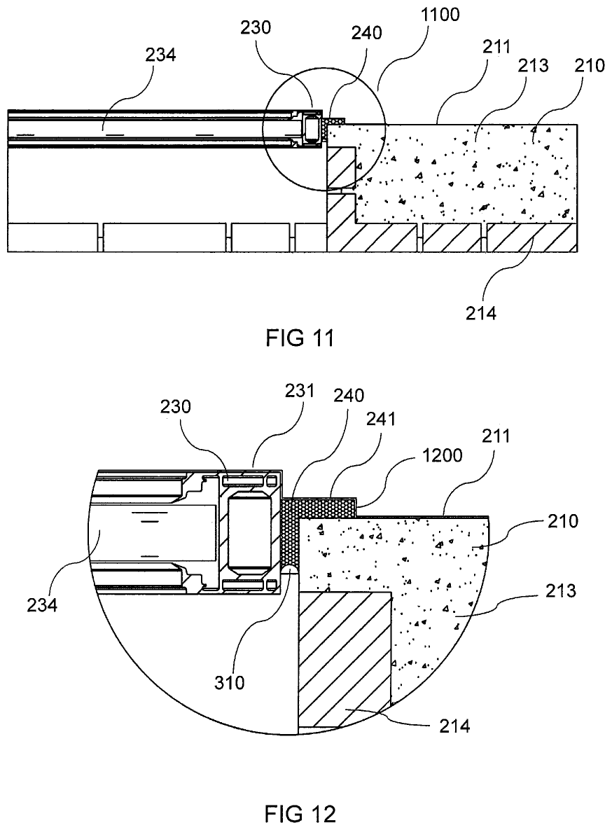

FIG. 11 shows an example of the subject matter described herein;

FIG. 12 shows an example of the subject matter described herein;

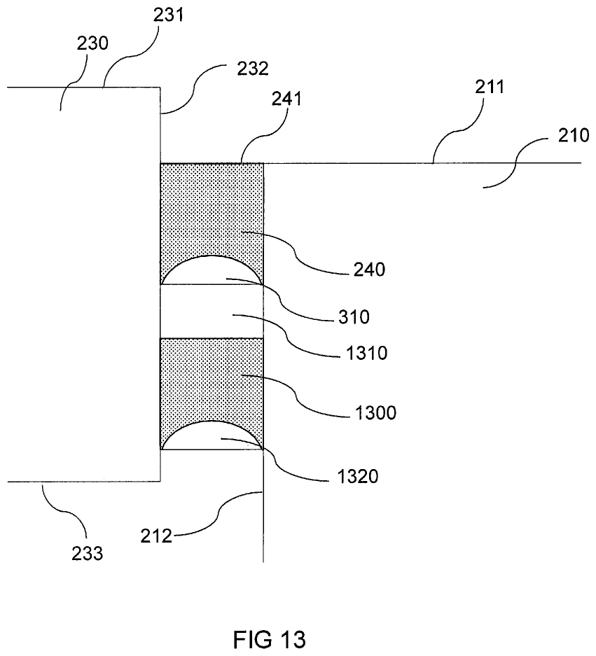

FIG. 13 shows an example of the subject matter described herein.

### DETAILED DESCRIPTION

The FIGs and examples illustrated below provide example methods and systems that provide a window frame 230 supported within a window opening 220 of a precast building component 210.

For example, FIG. 1 illustrates an example method 100. The method comprises in block 110, positioning a window frame 230 within a window opening 220 of a precast building component 210. The precast building component 210 comprises solidified settable material 213.

The method 100 comprises, in block 120, forming a void between the window frame and the precast building component. The void surrounds the window frame. Barrier material is placed within the gap between opposing surfaces of the window frame and the precast building component to form a boundary of the void.

The method comprises, in block 130, filling the void 300 with a settable adhesive sealant. The settable adhesive sealant, once set, provides a continuous seal 240 that surrounds the window frame 230 and supports the window frame 230 within the opening 220.

The continuous seal 240 can provide both structural support for the window frame 230 along with all necessary air and water performance, whereas in previous methods multiple components were required. For example, previous methods of installing a window frame within a precast building component included mounting the window frame to the precast building component using brackets to provide structural support and providing sealing by sealing strips fitted to the gaps between the window frame and the precast building component.

In previous methods, sealing strips needed to be applied to the front side of the window frame and the rear side of the window frame to provide necessary air and water performance. In some examples, the continuous seal 240 provides all the necessary sealing for air and water performance and so this reduces the complexity of the installation of the window frame into the precast building component.

By providing a continuous seal 240 around the window frame 230 that supports the window frame 240 within the window opening 230, this can even out the load points on the window frame 230 and the precast building component 210, producing less localized stress compared to if the window frame 230 was supported in the precast building component 210 with only brackets spaced around different parts of the window frame 230.

FIG. 2A illustrates an example precast building component and window frame system 200. The system 200 comprises: a precast building component 210. The precast building component 210 comprises solidified settable material 213 and a window opening 220. The system 200 additionally comprises a window frame 230 supported within the window opening 220. The window frame 230 is surrounded by a continuous seal 240. The continuous seal 240 supports the window frame 230 within the window opening 220. The continuous seal 240 comprises a settable adhesive sealant that has set.

FIG. 2B illustrates the precast building component 210 before the window frame 230 has been positioned within the window opening 220. The precast building component 210 with one or more window openings 220 can be referred to as a doughnut precast building component.

FIG. 3 illustrates part of an example precast building component and window frame system 200. FIG. 3 illustrates a cross-section of part of the system 200. FIG. 3 illustrates the system 200 prior to the settable adhesive sealant having filled the void 300.

As illustrated in FIG. 3 the barrier material 310 has been placed within the gap between opposing surfaces 232, 212 of the window frame 230 and the precast building component 210. The barrier material 310 forms a boundary of the void 300. In this example at least part of the surfaces 232, 212 provide other boundaries of the void 300.

The barrier material 310 can be provided by any suitable material that prevents the settable adhesive sealant from passing through when the void 300 is filled. For example, the barrier material 310 can be provided by one or more polystyrene backers, such as polystyrene backer rods. In other examples the barrier material 310 is provided by expanding foam tape. In the examples where the barrier material 310 is provided by polystyrene backer rods, these can be removed after the settable adhesive sealant has set. In examples where the barrier material 310 is expanding foam tape this can be retained in place after the settable adhesive sealant has set to form a finishing surface for the continuous seal 240. In examples where the barrier material 310 is expanding foam tape, the expanding foam can be checked to ensure it is secured to the surfaces 232, 331 so that it retains the settable adhesive sealant in place when it is placed within the void 30.

FIG. 4 illustrates an example system 200 after the void 300 has been filled with the settable adhesive sealant, in accordance with block 130 of method 100. In this example the void 300 is filled with the settable adhesive sealant up to be level with a face 211 of the precast building component 210. In this example the face 211 is the rear face 211 of the precast building component 210.

The settable adhesive sealant, once set to form the continuous seal 240, bonds the window frame 230 to the precast building component 210.

The continuous seal 240 can provide a hermetic seal between the window frame 230 and the precast building component 210. This means that air and water cannot pass from the front face 233 of the window frame 230 through the gap between surfaces 232, 212 to the rear face 231 of the window frame 230, or vice versa.

The settable adhesive sealant can be a pourable liquid, which can make it easier to form a seal between the window frame 230 and the precast building component 210 compared to, for example, using sealing strips, which require more skilled workmanship.

In some examples the precast building component 210 is laid flat whilst the window frame 230 is positioned and whilst the void 300 is filled with the settable adhesive sealant. In these examples, the precast building component 210 is laid flat so that the rear face 211 of the precast building component 210 is at least substantially parallel to the ground.

By laying the precast building component 210 flat, this provides an easy way to fill the void 300 with the settable adhesive sealant, as gravity will naturally force the sealant against the barrier material 310 and against the surfaces 232, 212 and easily allows a level surface of the top end 241 of the continuous seal 240 as illustrated in FIG. 4.

The integrity of the seal 240 and assurance that the adhesive sealant has bonded to all necessary surfaces can be checked by ensuring the settable adhesive sealant fills the void 300 according to the specific design of the seal 240 and that the settable adhesive sealant has not run through to the other side of the boundary material 310. This method of checking, which can form part of the method 100, has the benefit of enabling checking of the integrity of a seal before the precast building component is installed in the associated building.

Any suitable props, brackets and other supports can be used to position the precast building component 210 and the window frame 230 as required and secure them in the correct position to prevent any movement.

In some examples the precast building component 210 is laid flat on a table. In some examples the precast building component 210 is supported so that the window opening 220 is free from obstructions for positioning of the window frame 210.

In some examples the precast building component 210 is stood up whilst the window frame 230 is positioned and whilst the void 300 is filled with the settable adhesive sealant. In these examples, additional void boundaries are provided to prevent the settable adhesive sealant escaping the void 300. For example, additional boundaries may be placed next to where the top end 241 of the seal 240 is formed. In these examples, to allow access to the void 300, the void 300 may be filled in vertical sections with additional void boundaries placed as the void is filled up vertically.

In some examples one or more brackets are fitted to the window frame 230 and the precast building component 210 to provide additional support to the window frame 230 within the window opening 220.

FIG. 5 illustrates part of an example precast building component and window frame system 200. In this example the precast building component 210 comprises multiple facing building members 214, for example brick slips, which are bonded to the solidified settable material 213. In this example a pane of glass 234 is fixed within the window frame 230.

FIG. 6 illustrates a front view of the part of the system 200 illustrated in FIG. 5. The line 600 with arrows pointing down illustrates the cross-sectional view provided in FIG. 7, which looks down from the top of the cross-section. In FIG. 7 the circle 700 illustrates what is illustrated in FIG. 8.

In this example the rear face 211 of the precast building component 210 comprises a step 800 surrounding the gap between the opposing surfaces 232, 212 of the window frame 230 and the precast building component 210. The step 800 forms a boundary of void 300. The settable adhesive sealant fills the step 800 when the settable adhesive sealant fills the void, such that part of the continuous seal 240 is bonded to the rear face 211 of the precast building component 210.

This enables the seal 240 to use the rear face 211 of the precast building component as a support. In this example providing the step 800 also enables the top end 241 of the seal 240 to be level with the rest of the rear face 211. This can enable easier application of a membrane 810 to be adhered to at least part of the rear face 211, the top end 241 of the seal 240, at least part of the surface 232 of the window frame and at least part of the surface 231 of the window frame. The membrane can be, for example EPDM (Ethylene Propylene Diene Monomer) rubber. The membrane 810 can provide additional protection to the seal 240.

In this example the barrier material 310 has been removed.

FIG. 9 illustrates part of another example system 200. FIG. 10 shows a front view of the example system 200 illustrated in FIG. 9. The line 1000 with arrows pointing down illustrates the cross-sectional view illustrated in FIG. 11, which looks down from the top of the cross-section. The circle 1100 in FIG. 11 illustrates what is illustrated in FIG. 12.

In this example part of the seal 240 is bonded to part of the rear face 211 of the precast building component 210. To provide the seal 240 illustrated in FIG. 12, formwork components are placed on the rear face 211 of the precast building component 210 to form a boundary of the void 300. The formwork is spaced from the gap between the opposing surfaces 232, 212 of the window frame 230 and the precast building component 210 so that when the void 300 is filled with the settable adhesive sealant, part of the seal 240 is bonded part of the face 211 of the precast building component as illustrated in FIG. 12. The end 1200 of the seal 240 shows the position at which the formwork was placed during the method of manufacturing the system 200.

FIG. 13 illustrates part of another example precast building component and window frame system 200.

In this example the system 200 additionally comprises a secondary continuous seal 1300 comprising settable adhesive sealant that has set. The secondary continuous seal 1300 surrounds the window frame 230 and supports the window frame 230 within the window opening 220. An air gap 1310 and the barrier material 310 separates the continuous seal 240 and the secondary continuous seal 1300.

In other examples the barrier material 310 has been removed and so only the air gap 1310 separates the continuous seal 240 and the secondary continuous seal 1300.

To form the secondary continuous seal 1300, a secondary void is formed between the window frame 230 and the precast building component 210. The secondary void surrounds the window frame 230. Secondary barrier material 1320 is placed within the gap between opposing surfaces 232, 212 of the window frame 230 and the precast building component 210 to form a secondary boundary. The secondary void is filled with a settable adhesive sealant. The settable adhesive sealant, once set, provides the secondary continuous seal 1300. In some examples the secondary continuous seal 1300 is formed prior to the continuous seal 240.

In the examples illustrated and described, the solidified settable material 213 can be cementitious. In the examples and illustrations described, the solidified settable material 213 can comprise concrete.

In the examples described and illustrated, one or more glass panes 234 can be secured within the window frame 230 before positioning the window frame 230 within the window opening 220.

In the examples illustrated and described, one or more glass panes 234 can be secured within the window frame 230 after positioning the window frame 230 within the window opening 220.

In the examples illustrated and described, the settable adhesive sealant can be any suitable settable adhesive sealant that has a viscosity sufficient to fill the space within the void 300 to ensure that when the void 300 is filled the settable adhesive sealant fills the space required and bonds to the window frame 230, and the precast building component 210.

The void is defined by the boundaries described and an open end which the settable adhesive sealant is filled up to. The settable adhesive sealant can be filled to any indicated level in line with the structural requirements of the design of the window frame and/or the design of the precast building component. For example, the settable adhesive sealant is filled to be flush or raised above the rear face 211 of the precast building component by a set amount, for example 5 mm.

In some examples a primer is placed upon the surfaces of the window frame 230 and/or the precast building component 210 that the settable adhesive sealant is bonded to.

The methods described above can be carried out in a temperature-controlled environment, which can be a dry environment.

The window frame 230 can comprise, for example, aluminum, timber, or a composite.

The gap between the surfaces 232, 212 of the window frame 230 and the precast building component 210 can be, in some examples, in the range of 5 mm to 30 mm.

The settable adhesive sealant can be a curable adhesive sealant, and to set the settable adhesive sealant, the settable adhesive sealant is allowed to cure in accordance with the manufacturer's guidance.

In the examples illustrated and described, the precast building component can form a building panel, for part of a wall of a building. The building can comprise multiple panels for form a wall. The precast building component can comprise multiple window openings 210, which each can be filled with any of the window frames 230 described with any of the continuous seals 240, 1300 described.

The blocks illustrated in FIG. 1 may represent steps in a method. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1.-25. (canceled)

26. A method comprising:
positioning a window frame within a window opening of a precast building component, wherein the precast building component comprises solidified settable material;
forming a void between the window frame and the precast building component, wherein the void surrounds the window frame;
wherein barrier material is placed within a gap between opposing surfaces of the window frame and of the precast building component to form a boundary of the void, wherein at least part of the opposing surfaces form other boundaries of the void, and wherein the void is defined by the boundary and the other boundaries and an open end;
filling the void with a settable adhesive sealant, up to the open end of the void;
wherein the settable adhesive sealant, once set, provides a continuous seal that surrounds the window frame and supports the window frame within the window opening.

27. A method as claimed in claim 26, wherein the seal provides a hermetic seal between the window frame and the precast building component.

28. A method as claimed in claim 26, wherein the precast building component is laid flat whilst the window frame is positioned and whilst the void is filled with the settable adhesive sealant.

29. A method as claimed in claim 26, wherein the precast building component is stood up whilst the window frame is positioned and whilst the void is filled with the settable adhesive sealant, wherein additional void boundaries are provided to prevent the settable adhesive sealant escaping the void.

30. A method as claimed in claim 26, wherein one or more brackets are fitted to the window frame and the precast building component to provide additional support to support the window frame within the window opening.

31. A method as claimed in claim 26, wherein the method additionally comprises:
forming a secondary continuous seal that surrounds the window frame and supports the window frame within the window opening;
wherein the secondary continuous seal is formed by:
forming a secondary void between the window frame and the precast building component, wherein the secondary void surrounds the window frame; wherein secondary barrier material is placed within the gap between opposing surfaces of the window frame and the precast building component to form a secondary boundary;
filling the secondary void with a settable adhesive sealant;
wherein the settable adhesive sealant, once set, provides the secondary continuous seal;
wherein an air gap and/or the boundary separates the continuous seal and the secondary continuous seal.

32. A method as claimed in claim 26, wherein the void is filled by filling the settable adhesive sealant up to be level with a face of the precast building component.

33. A method as claimed in claim 26, wherein formwork components are placed on a face of the precast building component to form an additional boundary of the void, wherein the formwork is spaced from the gap between opposing surfaces of the window frame and the precast building component so that when the void is filled with the settable adhesive sealant, part of the seal is bonded to at least part of the face of the precast building component.

34. A method as claimed in claim 26, wherein a face of the precast building component comprises a step surrounding the gap between the opposing surfaces of the window frame and the precast building component, wherein the step forms an additional void boundary, wherein when the settable adhesive sealant fills the void it fills the step, such that part of the seal is bonded to at least part of the face of the precast building component.

35. A method as claimed in claim 26, wherein the solidified settable material is cementitious.

36. A precast building component and window frame system, comprising:
a precast building component, the precast building component comprising solidified settable material and a window opening;
a window frame supported within the window opening;
wherein the window frame is surrounded by a continuous seal, wherein the continuous seal supports the window frame within the window opening;
wherein the continuous seal comprises a settable adhesive sealant that has set within a gap between opposing surfaces of the window frame and of the precast building component, wherein the settable adhesive sealant has a first boundary within the gap, other boundaries formed by the opposing surfaces, and extends to a further boundary flush with or raised above a rear face of the precast building component.

37. A system as claimed in claim 36, wherein the seal provides a hermetic seal between the window frame and the precast building component.

38. A system as claimed in claim 36, wherein the system additionally comprises one or more brackets, fitted to the window frame and the precast building component, to provide additional support to support the window frame within the window opening.

39. A system as claimed in claim 36, wherein the system additionally comprises a secondary continuous seal comprising settable adhesive sealant that has set, wherein the secondary continuous seal surrounds the window frame and supports the window frame within the window opening;
wherein an air gap and/or the boundary separates the continuous seal and the secondary continuous seal.

40. A system as claimed in claim 36, wherein one end of the seal is level with a face of the precast building component.

41. A system as claimed in claim 36, wherein part of the seal is bonded to at least part of a face of the precast building component.

42. A system as claimed in claim 36, wherein a face of the precast building component comprises a step surrounding the gap between the opposing surfaces of the window frame and the precast building component, wherein the seal is bonded to the step.

43. A system as claimed in claim 36, wherein the system additionally comprises one or more membranes that cover at least part of a surface of the window frame, one end of the continuous seal, and at least part of a face of the precast building component.

44. A system as claimed in claim 36, wherein the solidified settable material is cementitious.

45. A system as claimed in claim 36, wherein one or more glass panes are secured within the window frame.
